(19) United States
(12) Patent Application Publication
(10) Pub. No.: US 2020/0280503 A1
(43) Pub. Date: Sep. 3, 2020

(54) METHOD, APPARATUS, COMPUTER PROGRAM PRODUCT AND COMPUTER PROGRAM

(71) Applicant: NOKIA TECHNOLOGIES OY, Espoo (FI)

(72) Inventors: Mikko Aleksi Uusitalo, Helsinki (FI); Zexian Li, Espoo (FI); Dragan Samardzija, Highlands, NJ (US); Harish Viswanathan, Morristown, NJ (US)

(21) Appl. No.: 16/650,843

(22) PCT Filed: Sep. 26, 2017
(86) PCT No.: PCT/EP2017/074340

§ 371 Date: Mar. 25, 2020

(51) Int. Cl. H04L 12/26

(52) U.S. Cl. CPC H04L 43/10

(57) ABSTRACT

The disclosure relates to a method comprising: using information associated with a first application in a first device, said first application being configured to communicate with a corresponding second application in a second device via a communication link, and information associated with said communication link to determine a modified output; and causing said modified output to be provided to said corresponding second application via said communication link.

### FIELD OF THE INVENTION

The invention relates to a method, an apparatus, a computer program product and a computer program.

### BACKGROUND

A communication system can be seen as a facility that enables communication between two or more devices such as user terminals, machine-like terminals, base stations and/or other nodes by providing carriers between the communication devices. A communication system can be provided for example by means of a communication network and one or more compatible communication devices. The communication may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless system at least a part of communications between at least two stations occurs over wireless interfaces. Examples of wireless systems include public land mobile networks (PLMN), satellite based communication systems and different wireless local networks, for example wireless local area networks (WLAN). A local area wireless networking technology allowing devices to connect to a data network is known by the tradename Wi-Fi (or Wi-Fi). Wi-Fi is often used synonymously with WLAN. The wireless systems can be divided into cells, and are therefore often referred to as cellular systems.

A user can access a communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

A communication system and associated devices typically operate in accordance with a given standard or specification which sets out what the various entities associated with the system are permitted to do and how that should be achieved. Communication protocols and/or parameters which shall be used for the connection are also typically defined. An example of standardized communication system architectures is the long-term evolution (LTE) of the Universal Mobile Telecommunications System (UMTS) radio-access technology. The LTE has been and is being standardized by the 3rd Generation Partnership Project (3GPP). The LTE employs the Evolved Universal Terrestrial Radio Access Network (E-UTRAN) access. Further development of LTE are sometimes referred to as LTE Advanced (LTE-A). The current 3GPP standardization effort is directed to what is termed as the 5th Generation (5G) system. The 5G system is sometimes referred to as NR (new radio).

### SUMMARY

There is provided, in a first aspect, a method comprising: using information associated with a first application in a first device, said first application being configured to communicate with a corresponding second application in a second device via a communication link, and information associated with said communication link to determine a modified output; and causing said modified output to be provided to said corresponding second application via said communication link.

Information associated with the first application may comprise one or more heartbeat messages received from said first application.

The information associated with a first application may comprise information about a first periodicity of heartbeat messages.

The modified output may comprise heartbeat messages with a second periodicity different to the first periodicity.

The modified output may comprise no heartbeat messages for normal heartbeat operation.

The method may further comprise: determining a heartbeat anomaly.

The method may further comprise: causing information about said heartbeat anomaly to be transmitted to the second device via the communication link.

Determining a heartbeat anomaly may comprise determining an absence of heart beat messages.

The information associated with a first application may include a required maximum error probability.

The information associated with a first application may include a required minimum reliability.

The information associated with a first application may include a required maximum latency.

The information associated with said communication link may include an achievable maximum error probability.

The information associated with said communication link may include an achievable minimum reliability.

The information associated with said communication link may include an achievable maximum latency.

The method may further comprise: determining the second periodicity based on the information associated with the first application and the information associated with said communication link.

The method may further comprise: causing an indication of the second periodicity to be transmitted via the communication link.

The method may further comprise: causing an indication of acceptance of the second periodicity to be received on the communication link.

The communication link may be a 5G Ultra Reliable Low Latency Communications (URLLC) link.

The communication link may be a Long Term Evolution (LTE) link.

The method may be performed by a heartbeat proxy.

The heartbeat proxy may be provided by an adaption layer between an application layer and a packet data convergence protocol layer.

There is provided, in a second aspect, a method, comprising: causing a modified input to be received over a communication link, wherein the modified input is determined using information associated with a first application in a first device, said application being configured to communicate with a corresponding second application in a second device via a communication link, and information associated with said communication link.

The information associated with a first application may comprise one or more heartbeat messages received from said first application.

The information associated with a first application may comprise information about a first periodicity of heartbeat messages.

The modified input may comprise heartbeat messages with a second periodicity different to the first periodicity.

The second periodicity may be greater than or equal to the first periodicity.

The modified input may comprise no heartbeat messages for normal heartbeat operation.

The method may further comprise: causing information about a heartbeat anomaly to be received via the communication link.

The method may further comprise: causing a heartbeat anomaly to be indicated to the second application.

Causing a heartbeat anomaly to be indicated may include causing a lack of heartbeat to be indicated.

The information associated with a first application may include a required maximum error probability.

The information associated with a first application may include a required minimum reliability.

The information associated with a first application may include a required maximum latency.

The information associated with said communication link may include an achievable maximum error probability.

The information associated with said communication link may include an achievable minimum reliability.

The information associated with said communication link may include an achievable maximum latency.

The second periodicity may be determined based on the information associated with a first application and the information associated with said communication link.

The method may further comprise: causing an indication of the second periodicity to be received via the communication link.

The method may further comprise: causing an indication of acceptance of the second periodicity to be transmitted on the communication link.

The communication link may be a 5G Ultra Reliable Low Latency Communications (URLLC) link.

The communication link may be a Long Term Evolution (LTE) link.

The method may be performed by a heartbeat proxy.

The heartbeat proxy may be provided by providing an adaption layer between an application layer and a packet data convergence protocol layer.

There is provided, in a third aspect, an apparatus comprising: means for using information associated with a first application in a first device, said first application being configured to communicate with a corresponding second application in a second device via a communication link, and information associated with said communication link to determine a modified output; and means for causing said modified output to be provided to said corresponding second application via said communication link.

Information associated with the first application may comprises one or more heartbeat messages received from said first application.

The information associated with a first application may comprise information about a first periodicity of heartbeat messages.

The modified output may comprise heartbeat messages with a second periodicity different to the first periodicity.

The modified output may comprise no heartbeat messages for normal heartbeat operation.

The apparatus may further comprise: means for determining a heartbeat anomaly.

The apparatus may further comprise: means for causing information about said heartbeat anomaly to be transmitted to the second device via the communication link.

The means for determining a heartbeat anomaly may comprise means for determining an absence of heart beat messages.

The information associated with a first application may include a required maximum error probability.

The information associated with a first application may include a required minimum reliability.

The information associated with a first application may include a required maximum latency.

The information associated with said communication link may include an achievable maximum error probability.

The information associated with said communication link may include an achievable minimum reliability.

The information associated with said communication link may include an achievable maximum latency.

The apparatus may further comprise: means for determining the second periodicity based on the information associated with the first application and the information associated with said communication link.

The apparatus may further comprise: means for causing an indication of the second periodicity to be transmitted via the communication link.

The apparatus may further comprise: means for causing an indication of acceptance of the second periodicity to be received on the communication link.

The communication link may be a 5G Ultra Reliable Low Latency Communications (URLLC) link.

The communication link may be a Long Term Evolution (LTE) link.

The apparatus may comprise a heartbeat proxy.

The heartbeat proxy may be provided by an adaption layer between an application layer and a packet data convergence protocol layer.

There is provided, in a fourth aspect, an apparatus, comprising: means for causing a modified input to be received over a communication link, wherein the modified input is determined using information associated with a first application in a first device, said application being configured to communicate with a corresponding second application in a second device via a communication link, and information associated with said communication link.

The information associated with a first application may comprise one or more heartbeat messages received from said first application.

The information associated with a first application may comprise information about a first periodicity of heartbeat messages.

The modified input may comprise heartbeat messages with a second periodicity different to the first periodicity.

The second periodicity may be greater than or equal to the first periodicity.

The modified input may comprise no heartbeat messages for normal heartbeat operation.

The apparatus may further comprise: means for causing information about a heartbeat anomaly to be received via the communication link.

The apparatus may further comprise: means for causing a heartbeat anomaly to be indicated to the second application.

The means for causing a heartbeat anomaly to be indicated may include causing a lack of heartbeat to be indicated.

The information associated with a first application may include a required maximum error probability.

The information associated with a first application may include a required minimum reliability.

The information associated with a first application may include a required maximum latency.

The information associated with said communication link may include an achievable maximum error probability.

The information associated with said communication link may include an achievable minimum reliability.

The information associated with said communication link may include an achievable maximum latency.

The second periodicity may be determined based on the information associated with a first application and the information associated with said communication link.

The apparatus may further comprise: means for causing an indication of the second periodicity to be received via the communication link.

The apparatus may further comprise: means for causing an indication of acceptance of the second periodicity to be transmitted on the communication link.

The communication link may be a 5G Ultra Reliable Low Latency Communications (URLLC) link.

The communication link may be a Long Term Evolution (LTE) link.

The apparatus may comprise a heartbeat proxy.

The heartbeat proxy may be provided by providing an adaption layer between an application layer and a packet data convergence protocol layer.

There is provided, in a fifth aspect, an apparatus comprising at least one processor and at least one memory including a computer program code, the at least one memory and the computer program code configured to, with the at least one processor, cause the apparatus at least to: use information associated with a first application in a first device, said first application being configured to communicate with a corresponding second application in a second device via a communication link, and information associated with said communication link to determine a modified output; and cause said modified output to be provided to said corresponding second application via said communication link.

Information associated with the first application may comprises one or more heartbeat messages received from said first application.

The information associated with a first application may comprise information about a first periodicity of heartbeat messages.

The modified output may comprise heartbeat messages with a second periodicity different to the first periodicity.

The modified output may comprise no heartbeat messages for normal heartbeat operation.

The computer program code may further be configured to, with the at least one processor, cause the apparatus to: determine a heartbeat anomaly.

The computer program code may further be configured to, with the at least one processor, cause the apparatus to: cause information about said heartbeat anomaly to be transmitted to the second device via the communication link.

Determining a heartbeat anomaly may comprise means for determining an absence of heart beat messages.

The information associated with a first application may include a required maximum error probability.

The information associated with a first application may include a required minimum reliability.

The information associated with a first application may include a required maximum latency.

The information associated with said communication link may include an achievable maximum error probability.

The information associated with said communication link may include an achievable minimum reliability.

The information associated with said communication link may include an achievable maximum latency.

The computer program code may further be configured to, with the at least one processor, cause the apparatus to: determine the second periodicity based on the information associated with the first application and the information associated with said communication link.

The computer program code may further be configured to, with the at least one processor, cause the apparatus to: cause an indication of the second periodicity to be transmitted via the communication link.

The computer program code may further be configured to, with the at least one processor, cause the apparatus to: cause an indication of acceptance of the second periodicity to be received on the communication link.

The communication link may be a 5G Ultra Reliable Low Latency Communications (URLLC) link.

The communication link may be a Long Term Evolution (LTE) link.

The apparatus may comprise a heartbeat proxy.

The heartbeat proxy may be provided by an adaption layer between an application layer and a packet data convergence protocol layer.

There is provided, in a sixth aspect, an apparatus comprising at least one processor and at least one memory including a computer program code, the at least one memory and the computer program code configured to, with the at least one processor, cause the apparatus at least to: cause a modified input to be received over a communication link, wherein the modified input is determined using information associated with a first application in a first device, said application being configured to communicate with a corresponding second application in a second device via a communication link, and information associated with said communication link.

The information associated with a first application may comprise one or more heartbeat messages received from said first application.

The information associated with a first application may comprise information about a first periodicity of heartbeat messages.

The modified input may comprise heartbeat messages with a second periodicity different to the first periodicity.

The second periodicity may be greater than or equal to the first periodicity.

The modified input may comprise no heartbeat messages for normal heartbeat operation.

The computer program code may further be configured to, with the at least one processor, cause the apparatus to: cause information about a heartbeat anomaly to be received via the communication link.

The computer program code may further be configured to, with the at least one processor, cause the apparatus to: cause a heartbeat anomaly to be indicated to the second application.

Causing a heartbeat anomaly to be indicated may include causing a lack of heartbeat to be indicated.

The information associated with a first application may include a required maximum error probability.

The information associated with a first application may include a required minimum reliability.

The information associated with a first application may include a required maximum latency.

The information associated with said communication link may include an achievable maximum error probability.

The information associated with said communication link may include an achievable minimum reliability.

The information associated with said communication link may include an achievable maximum latency.

The second periodicity may be determined based on the information associated with a first application and the information associated with said communication link.

The computer program code may further be configured to, with the at least one processor, cause the apparatus to: cause an indication of the second periodicity to be received via the communication link.

The computer program code may further be configured to, with the at least one processor, cause the apparatus to: cause an indication of acceptance of the second periodicity to be transmitted on the communication link.

The communication link may be a 5G Ultra Reliable Low Latency Communications (URLLC) link.

The communication link may be a Long Term Evolution (LTE) link.

The apparatus may comprise a heartbeat proxy.

There is provided, in a seventh aspect, a computer program embodied on a non-transitory computer-readable storage medium, the computer program comprising program code for controlling a process to execute a process, the process comprising: using information associated with a first application in a first device, said first application being configured to communicate with a corresponding second application in a second device via a communication link, and information associated with said communication link to determine a modified output; and causing said modified output to be provided to said corresponding second application via said communication link.

Information associated with the first application may comprises one or more heartbeat messages received from said first application.

The information associated with a first application may comprise information about a first periodicity of heartbeat messages.

The modified output may comprise heartbeat messages with a second periodicity different to the first periodicity.

The modified output may comprise no heartbeat messages for normal heartbeat operation.

The process may further comprise: determining a heartbeat anomaly.

The process may further comprise: causing information about said heartbeat anomaly to be transmitted to the second device via the communication link.

Determining a heartbeat anomaly may comprise means for determining an absence of heart beat messages.

The information associated with a first application may include a required maximum error probability.

The information associated with a first application may include a required minimum reliability.

The information associated with a first application may include a required maximum latency.

The information associated with said communication link may include an achievable maximum error probability.

The information associated with said communication link may include an achievable minimum reliability.

The information associated with said communication link may include an achievable maximum latency.

The process may further comprise: determining the second periodicity based on the information associated with the first application and the information associated with said communication link.

The process may further comprise: causing an indication of the second periodicity to be transmitted via the communication link.

The process may further comprise: causing an indication of acceptance of the second periodicity to be received on the communication link.

The communication link may be a 5G Ultra Reliable Low Latency Communications (URLLC) link.

The communication link may be a Long Term Evolution (LTE) link.

The process may be performed by a heartbeat proxy.

The heartbeat proxy may be provided by an adaption layer between an application layer and a packet data convergence protocol layer.

There is provided, in an eighth aspect, a computer program embodied on a non-transitory computer-readable storage medium, the computer program comprising program code for controlling a process to execute a process, the process comprising:

causing a modified input to be received over a communication link, wherein the modified input is determined using information associated with a first application in a first device, said application being configured to communicate with a corresponding second application in a second device via a communication link, and information associated with said communication link.

The information associated with a first application may comprise one or more heartbeat messages received from said first application.

The information associated with a first application may comprise information about a first periodicity of heartbeat messages.

The modified input may comprise heartbeat messages with a second periodicity different to the first periodicity.

The second periodicity may be greater than or equal to the first periodicity.

The modified input may comprise no heartbeat messages for normal heartbeat operation.

The process may further comprise: causing information about a heartbeat anomaly to be received via the communication link.

The process may further comprise: causing a heartbeat anomaly to be indicated to the second application.

Causing a heartbeat anomaly to be indicated may include causing a lack of heartbeat to be indicated.

The information associated with a first application may include a required maximum error probability.

The information associated with a first application may include a required minimum reliability.

The information associated with a first application may include a required maximum latency.

The information associated with said communication link may include an achievable maximum error probability.

The information associated with said communication link may include an achievable minimum reliability.

The information associated with said communication link may include an achievable maximum latency.

The second periodicity may be determined based on the information associated with a first application and the information associated with said communication link.

The process may further comprise: causing an indication of the second periodicity to be received via the communication link.

The process may further comprise: causing an indication of acceptance of the second periodicity to be transmitted on the communication link.

The communication link may be a 5G Ultra Reliable Low Latency Communications (URLLC) link.

The communication link may be a Long Term Evolution (LTE) link.

The process may be performed by a heartbeat proxy.

In the above, many different embodiments have been described. It should be appreciated that further embodiments may be provided by the combination of any two or more of the embodiments described above.

### BRIEF DESCRIPTION OF THE DRAWING

Some embodiments will now be described in further detail, by way of example only, with reference to the following examples and accompanying drawings, in which:

FIG. 1 illustrates communication system;

FIG. 2 illustrates a communication device;

FIG. 3 illustrates the protocol stack of communication devices communicating over a communication link;

FIG. 4 illustrates a system according to an embodiment;

FIG. 5 illustrates the protocol stack of communication devices communicating over a communication link according to an embodiment;

FIG. 6 illustrates an environment in which a system according to an embodiment can be implemented;

FIG. 7 illustrates a method performed by an adaption layer on the transmit side; and

FIG. 8 illustrates a method performed by an adaption layer on the receive side.

### DETAILED DESCRIPTION OF THE DRAWINGS

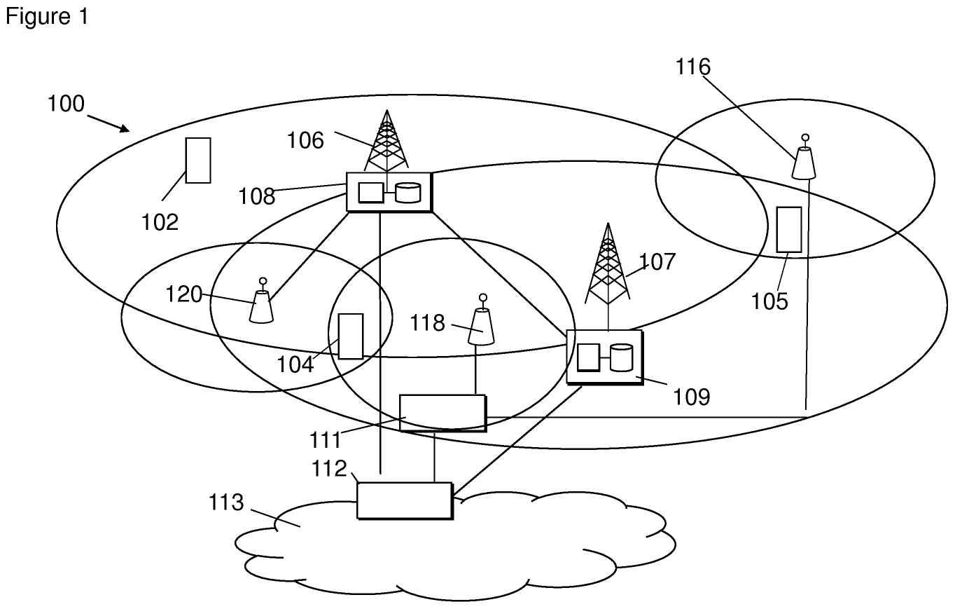

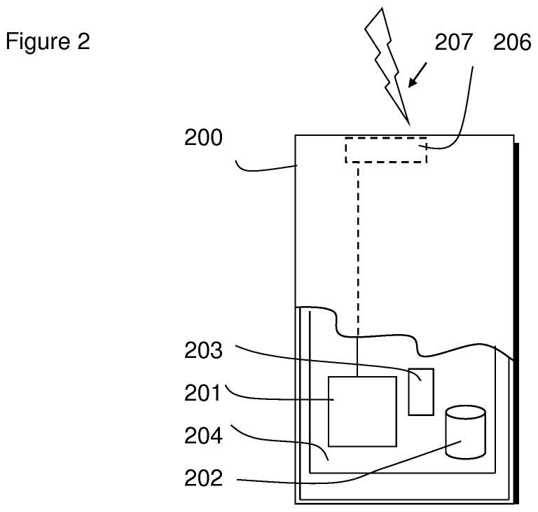

Before explaining in detail embodiments, certain general principles of a communication system, a mobile communication device and a control apparatus are briefly explained with reference to FIGS. 1 and 2 to assist in understanding the technology underlying the described invention.

In a wireless communication system 100, such as that shown in FIG. 1, wireless communication devices, for example, machine-type communications MTC devices 102, 104, 105 are provided wireless access via at least one base station or similar wireless transmitting and/or receiving wireless infrastructure node or point. Such a node can be, for example, a base station or an eNodeB (eNB), or in a 5G system a Next Generation NodeB (gNB), or other wireless infrastructure node. These nodes will be generally referred to as base stations. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller. Other examples of radio access system comprise those provided by base stations of systems that are based on technologies such as 5G or new radio, wireless local area network (WLAN) and/or WiMax (Worldwide Interoperability for Microwave Access). A base station can provide coverage for an entire cell or similar radio service area.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible wireless communication device will now be described in more detail with reference to FIG. 2 showing a schematic, partially sectioned view of a communication device 200. Such a communication device is often referred to as an endpoint device. An appropriate communication device may be provided by any device capable of sending and receiving radio signals.

A communication device may be for example a mobile device, that is, a device not fixed to a particular location, or it may be a stationary device. The communication device may need human interaction for communication, or may not need human interaction for communication.

The communication device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the wireless device.

A communication device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. Furthermore, a wireless communication device may comprise appropriate connectors (either wired or wireless) to other devices and/or for connecting external accessories. The communication devices 102, 104, 105 may access the communication system based on various access techniques.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced NodeBs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Another example of a communications system is the 5G concept. Network architecture in 5G may be quite similar to that of the LTE-advanced. Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. 5G may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. The base stations in 5G may be referred to as gNB.

The 5G system is planned to be introduced in the early 2020s, enabling expansion of International Mobile Telecommunications (IMT) that go beyond those of IMT-2000 and IMT-Advanced mobile broadband (MBB) service, also envisioning to address new services and use cases. These new services are not only for human interaction, but also for a huge growth in machine-type communications (MTC) driven by e.g., factory automation and flexible process control. 5G ultra reliable and low-latency communications (URLLC) is one enabler to support these new services.

One requirement on URLLC currently being studied in 3GPP RAN WG is 99.999 reliability under the radio latency bound of 1 ms [3GPP TR38.913]. Namely, the maximum packet error probability must not be higher than 10⁻⁵, where maximum allowable radio latency, including retransmissions is down to 1 ms. With the new numerology consideration for 5G, for example, the 0.125 ms TTI size or even shorter mini-slot concept with each TTI containing both control and data information, there is a possibility to support transmissions with 1 ms latency.

While radio access is evolving through 3GPP, industrial networks are already using state-of-the-art ultra reliable protocols and mechanisms, such as Profisafe.

Profisafe is a fail-safe communication protocol in production and process automation. Profisafe allows the delivery of updated and correct data (data integrity) to the intended destination (authenticity) just in time (timeliness). To do so, Profisafe includes several safety mechanisms including the consecutive numbering of messages (sign-of-life), a time expectation with acknowledgement (watch-dog), a codename between sender and receiver (F-Address) and data integrity checks (CRC=cyclic redundancy check).

Using the consecutive numbering a receiver can determine whether or not it received the messages completely and within the correct sequence. Using the watch-dog a receiver can determine whether a message is received within a fault tolerance time, thus enabling the receiver to automatically initiate any necessary safety reactions on site, e.g. stoppage of movement. Using the F-Address a receiver can verify the authenticity and destination of a message. Finally, using the cyclic redundancy check (CRC) a receiver can determine whether a message is corrupted. More information about Profisafe can be found in “Profisafe System Description—Technology and Application”).

It should be appreciated that this one example of a system with which some embodiments may be used. Other embodiments may be used where heatbeat information or similar needs to be provided via a wireless link.

There is a desire for some embodiments to enable highly optimized transport of those industrial protocols over 5G radio access with minimal changes to industrial devices and control elements.

In conventional industrial solutions, regular heartbeat messages are sent over communication links to prove that communication devices (e.g. a machine and industrial controller) and connections are functioning properly. The heartbeat messages are required to go in both directions, but sometimes no acknowledgement messages to confirm reception are sent. With the current operation, the transmission takes place without considering the communication system capabilities in terms of reliability. To be more specific, no differentiation between radio-access technologies, i.e., their level of reliability is considered, thus the same transmission periodicity is applied. This will result in unnecessary transmission especially when high reliability is achievable. This may not be optimal and as 5G URLLC provides improved wireless performance, this operation can be optimized.

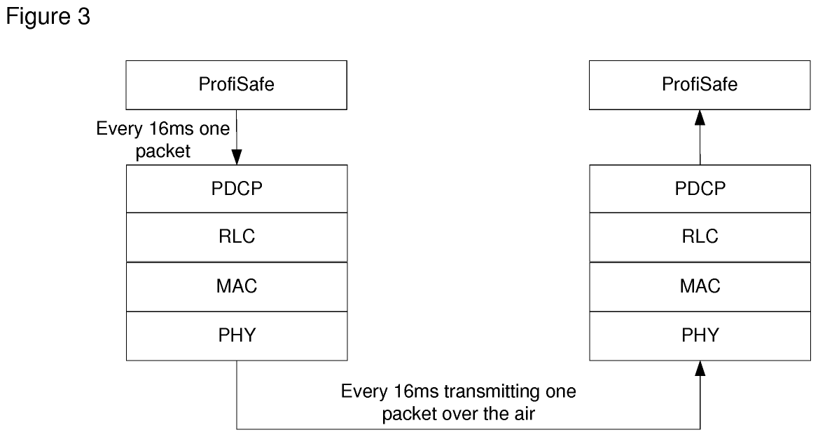

FIG. 3 shows an example protocol stack of communication devices communicating over a communication link (e.g. radio link). Each communication device includes an application layer (e.g. ProfiSafe layer), a packet data convergence protocol (PDCP) layer, a radio link control (RLC) layer, a medium access control (MAC) layer and a physical (PHY) layer.

In this example, each communication device periodically sends heartbeat messages every 16 ms. A watchdog needs to receive at least one in three consecutive heartbeat messages sent, otherwise it may take action such as an emergency stop. Therefore, for the 16 ms heartbeat periodicity, the maximum latency (i.e. maximum time window to get one correct heartbeat message) is 48 ms.

The heartbeat messages can be transmitted over the air via the communication link (e.g.an LTE radio link). Every 16 ms the application layer of a communication device delivers one packet and the packet gets delivered over the air. The transmission of the heartbeat messages consumes network resources affecting its capacity. However, the full-rate transmission of those messages may not be needed to facilitate proper operation of the system including its elements and functions such as the watchdog.

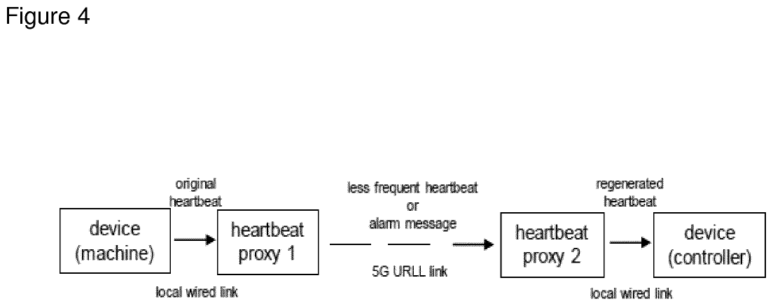

FIG. 4 shows a system according to an embodiment. The embodiment includes replacing current regular over-the-air heartbeat signals with virtual heartbeat signals. This may result in less frequent over-the-air messages, thus reducing the usage of the precious resources of the communication link. This may be done by introducing at each end of the reliable section of the communication link a heartbeat proxy. Some embodiments may enable either a support of (e.g. 2-3 times) more devices with the same amount of resources or a support of the same number of devices with less (e.g. 2-3 times) resources (or a combination of the two). Some embodiments use resources of the communication link flexibly depending on the radio technology and achievable capability.

In addition to improving efficiency, some embodiments may not require changes to the existing industrial protocols, communication devices and controllers. This may simplify the application of 5G in industrial settings, enabling easy and transparent replacement of the current fixed with wireless access.

At each end of the reliable section of the communication link a functional element heartbeat proxy, is introduced. In the course of normal operation, heartbeat proxy 1 monitors the original heartbeat messages generated by a communication device (e.g., a machine). On the other side, heartbeat proxy 2 regenerates the heartbeat messages and sends it to another communication device (i.e., an industrial controller). In this case either no message or a relatively infrequent message is sent over the air. Where a message is sent over the air, this may be at a lower frequency than that defined by a particular standard. For example the message is sent less frequently than every 16 ms.

When a certain heartbeat anomaly is detected, an ‘alarm’ message is sent by heartbeat proxy 1 over the air to heartbeat proxy 2 which then emulates the abnormal situation toward its endpoint device. The alarm message may be sent very reliably and quickly using 5G URLLC.

The heartbeat proxy 1 and heartbeat proxy 2 may be implemented by an adaption layer between the application layer and the packet data convergence protocol layer.

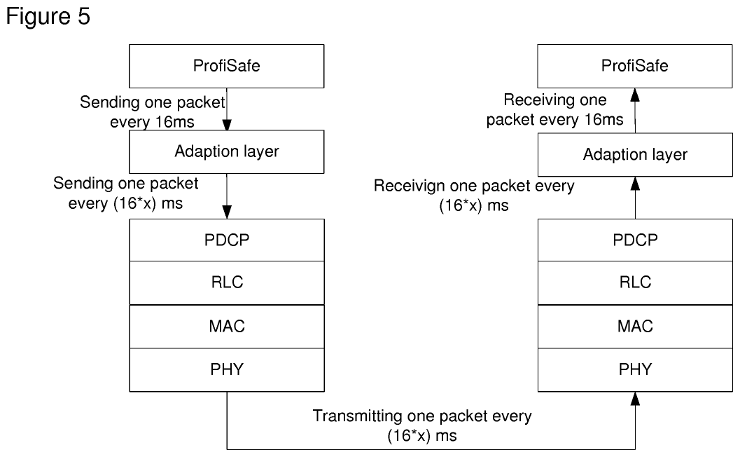

FIG. 5 shows the protocol stack of communication devices communicating over a communication link (e.g. 5G URLLC radio link) according to an embodiment. Each communication device includes an application layer (e.g. ProfiSafe layer), an adaption layer, a packet data convergence protocol (PDCP) layer, a radio link control (RLC) layer, a medium access control (MAC) layer and a physical (PHY) layer. The functions of the adaption layer may comprise one or more of the following.

The adaption layer on the transmit side may be configured to monitor a heartbeat based on heartbeat messages with an original periodicity received from the application layer.

The adaption layer on the transmit side may be configured to identify the application layer required capability, for example a required maximum error periodicity, a minimum reliability and/or a maximum latency.

The adaption layer on the transmit side may be configured to get reports from the network about the achievable capability of the communication link, for example an achievable maximum error periodicity, a minimum reliability and/or an achievable maximum latency.

The adaption layer on the transmit side may be configured to determine an adjusted periodicity that meets the required capability based on the achievable capability and agree on the adjusted periodicity with the adaption layer on the receive side.

For example, let us consider an example application where ProfiSafe messages are required to be delivered with a minimum reliability of 10⁻⁹ and a maximum latency of 48 ms. The maximum latency designates a time window within which one heartbeat message should be received correctly to avoid a determined action to be taken, for example an emergency stop. ProfiSafe heartbeat messages are generated with a periodicity of 16 ms. ProfiSafe ensures that the connection is such that there is normal operation and no emergency braking takes place erroneously. The same approach is used in many fields of automation.

As another example, in factory automation, one of the most discussed use case is cooperative robots. The robots can be configured to send heartbeat messages among themselves to make sure that all the functions are running properly. The periodicity of the heartbeat messages can be configured. Similar as the example above, there is one threshold which defines the maximal packet loss within a time period.

According to the 5G NR design target, a 5G URLLC communication link can achieve a maximum packet error probability of 10⁻⁵ and the maximum latency of 1 ms. Thus, transmissions of two virtual heartbeat messages every 48 ms is sufficient to meet the minimum reliability of 10⁻⁹ and a maximum latency of 48 ms. The adjusted periodicity can be set to 32 ms (i.e. lower than the original periodicity).

On the other hand, a LTE communication link can achieve a maximum error probability of 10⁻⁴ and a maximum latency in the order of 16 ms, depending on the deployment, but going often up to 100 ms or even longer in usual deployments. Thus, transmissions of three virtual heartbeat messages every 48 ms is necessary to meet the maximum error probability of 10⁻⁹ and the maximum latency of 48 ms. The adjusted periodicity may be set to 16 ms (i.e. equal to the original periodicity).

The adaption layer on the transmit and receive side may be configured to determine an adjusted periodicity when the application layer required capability and/or the radio-access achievable capability changes and agree on the adjusted periodicity with the adaption layer on the receive side. For example, the virtual heartbeat messages may be transmitted more frequently when the achievable maximum error probability increases or the achievable minimum reliability decreases. To the contrary, the virtual heartbeat messages may be transmitted less frequently when the achievable maximum error probability decreases or the achievable minimum reliability increases.

In the case of the heartbeat signalling is changing over time, by including a time stamp in the message, the adaption layer may be configured to generate a virtual heartbeat signal accordingly. Thus is if there is a need to change the heartbeat signalling, like the periodicity of the heartbeat messages, this information can be conveyed to the adaptation layer, allowing it to change its operation as well.

The adaption layer on the transmit side may be configured to detect an anomaly in or lack of the heartbeat and may be configured to generate an over-the-air alarm message.

The adaption layer on the receive side upon reception of the virtual heartbeat messages with an adjusted periodicity may be configured to emulate heartbeat messages with an original periodicity.

The adaption layer on the receive side upon reception of the alarm message may be configured to emulate a heartbeat anomaly or lack of it.

It will be understood that in the previous implementation, the controlling of the operation of the adaption layer is done via the application layer and via the entity running the application.

In another implementation, the adaption layer may be closely attached to the application layer. In this case, it is necessary for the adaption layer to have the capability of wireless communication link. The adaption layer may be part of the layers controlled by the wireless infrastructure vendor. The controlling of the operation of the adaption layer is done via the wireless infrastructure vendor.

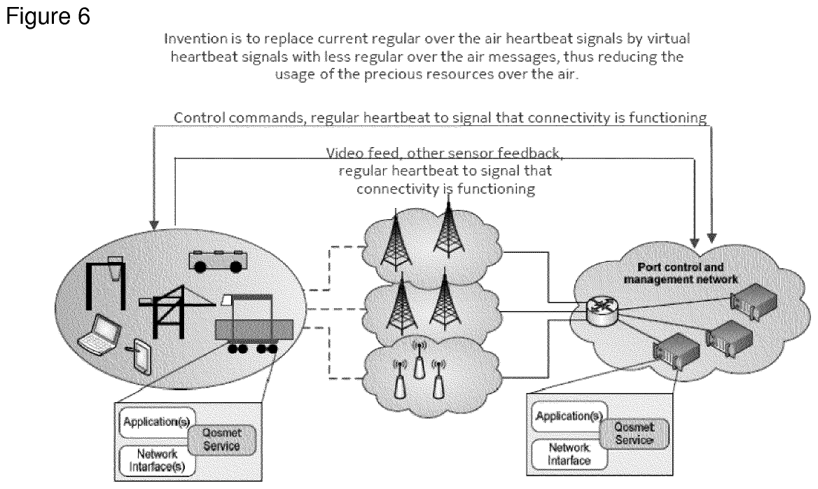

FIG. 6 shows an environment in which a system according to an embodiment can be implemented. The environment is a harbour and comprises cranes and other equipment sending video feed and sensor information and receiving control commands from industrial controllers to perform automated transport.

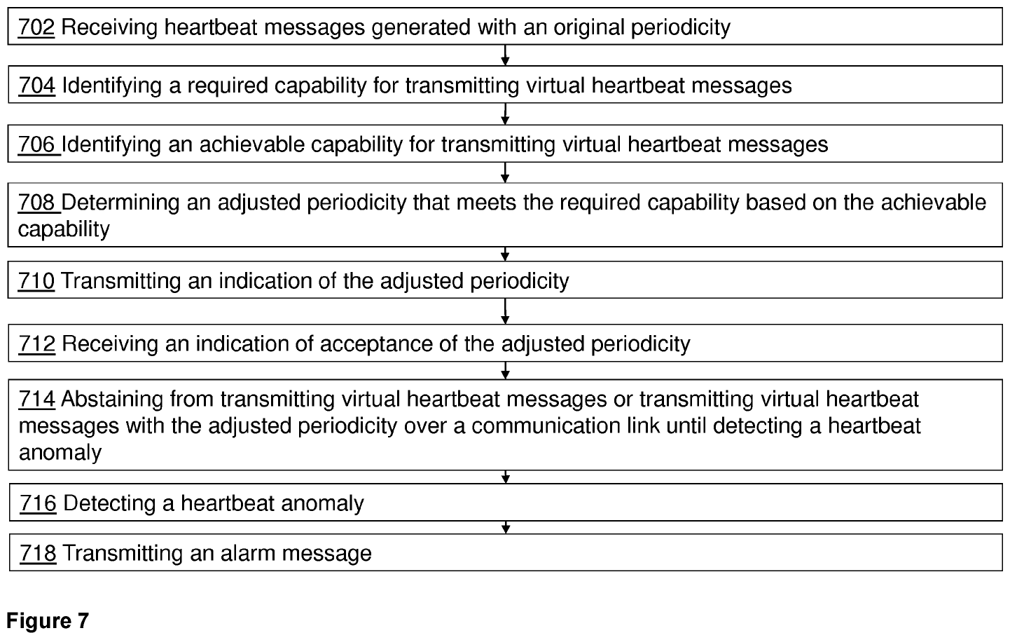

FIG. 7 shows an example method performed by an adaption layer on the transmit side. On step 702, the adaption layer on the transmit side receives heartbeat messages with an original periodicity (e.g. every 16 ms) from the application layer.

On step 704, the adaption layer on the transmit side identifies a required capability (e.g. required maximum error probability, minimum reliability and/or maximum latency) for transmitting virtual heartbeat messages. The required capability depends on the application executed (e.g. one application requires ProfiSafe message to be delivered with a maximum error probability of 10⁻⁹ and a maximum latency of 48 ms).

On step 706, the adaption layer on the transmit side identifies an achievable capability (e.g. achievable maximum error probability, minimum reliability and/or maximum latency) for transmitting virtual heartbeat messages. The achievable capability depends on the radio access technology of the communication link (e.g. a 5G ULLRC communication link can achieve a maximum error probability of 10⁻⁵ and a maximum latency of 1 ms).

On step 708, the adaption layer on the transmit side determines an adjusted periodicity that meets the required capability based on the achievable capability (e.g. every 32 ms).

On step 710, the adaption layer on the transmit side transmits an indication of the adjusted periodicity to the adaption layer on the receive side. The indication is transmitted successively via the packet data convergence protocol layer on the transmit side, the radio link control layer on the transmit side, the medium access control layer on the transmit side, the physical layer on the transmit side, the communication link, the physical layer on the receive side, the medium access control layer on the receive side, the radio link control layer on the receive side and the packet data convergence protocol layer on the receive side.

On step 712, the adaption layer on the transmit side receives an indication of acceptance of the adjusted periodicity from the adaption layer on the receive side. The indication is received successively via the packet data convergence protocol layer on the receive side, the radio link control layer on the receive side, the medium access control layer on the receive side, the physical layer on the receive side, the communication link, the physical layer on the transmit side, the medium access control layer on the transmit side, the radio link control layer on the transmit side and the packet data convergence protocol layer on the transmit side.

On step 714, the adaption layer on the transmit side abstains from transmitting virtual heartbeat messages or transmits virtual heartbeat messages with the adjusted periodicity to the adaption layer on the receive side until detecting a heartbeat anomaly. The virtual heartbeat messages are transmitted successively via the packet data convergence protocol layer on the transmit side, the radio link control layer on the transmit side, the medium access control layer on the transmit side, the physical layer on the transmit side, the communication link, the physical layer on the receive side, the medium access control layer on the receive side, the radio link control layer on the receive side and the packet data convergence protocol layer on the receive side.

On step 716, the adaption layer on the transmit side detects a heartbeat anomaly, for example a lack of heartbeat. If in step 714 the adaption layer on the transmit side transmitted the virtual heartbeat messages with the adjusted periodicity then such transmission is interrupted in response.

On step 718, the adaption layer on the transmit side finally transmits an alarm message to the adaption layer on the receive side. The alarm message is transmitted successively via the packet data convergence protocol layer on the transmit side, the radio link control layer on the transmit side, the medium access control layer on the transmit side, the physical layer on the transmit side, the communication link, the physical layer on the receive side, the medium access control layer on the receive side, the radio link control layer on the receive side and the packet data convergence protocol layer on the receive side.

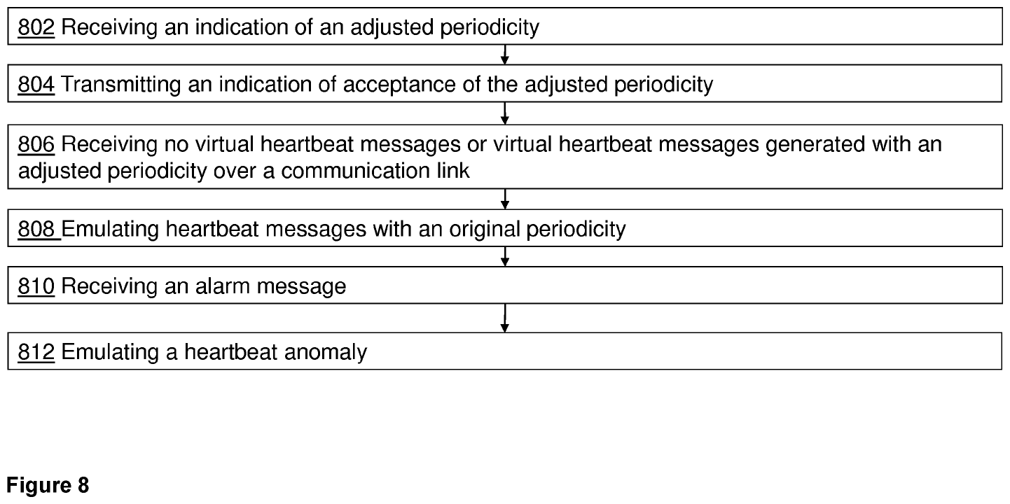

FIG. 8 shows an example method performed by an adaption layer on the receive side. On step 802, the adaption layer on the receive side receives an indication of an adjusted periodicity from the adaption layer on the transmit side. The indication is received successively via the packet data convergence protocol layer on the transmit side, the radio link control layer on the transmit side, the medium access control layer on the transmit side, the physical layer on the transmit side, the communication link, the physical layer on the receive side, the medium access control layer on the receive side, the radio link control layer on the receive side and the packet data convergence protocol layer on the receive side.

On step 804, the adaption layer on the receive side transmits an indication of acceptance of the adjusted periodicity to the adaption layer on the transmit side. The indication is transmitted successively via the packet data convergence protocol layer on the receive side, the radio link control layer on the receive side, the medium access control layer on the receive side, the physical layer on the receive side, the communication link, the physical layer on the transmit side, the medium access control layer on the transmit side, the radio link control layer on the transmit side and the packet data convergence protocol layer on the transmit side.

On step 806, the adaption layer on the receive side receives no virtual heartbeat messages or virtual heartbeat messages with an adjusted periodicity (e.g. every 32 ms) over a communication link.

On step 808, the adaption layer on the receive side emulates heartbeat messages with an original periodicity (e.g. every 16 ms) and transmits the emulated heartbeat messages to the application layer on the receive side.

On step 810, the adaption layer on the receive side receives an alarm message from the adaption layer on the transmit side. The alarm message is received successively via the packet data convergence protocol layer on the transmit side, the radio link control layer on the transmit side, the medium access control layer on the transmit side, the physical layer on the transmit side, the communication link, the physical layer on the receive side, the medium access control layer on the receive side, the radio link control layer on the receive side and the packet data convergence protocol layer on the receive side.

On step 812, the adaption layer on the receive side emulating a heartbeat anomaly and transmits the emulated heartbeat anomaly to the application layer on the receive side to take further action.

It will be understood that in the above embodiments, heartbeat messages are no longer transmitted with the original periodicity over the communication link. Instead, virtual messages are transmitted with the adjusted periodicity or alternatively no virtual heartbeat message are transmitted at all.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptions may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
using information associated with a first application in a first device, said first application being configured to communicate with a corresponding second application in a second device via a communication link, and information associated with said communication link to determine a modified output; and
causing said modified output to be provided to said corresponding second application via said communication link.

2. The method of claim 1, wherein said information associated with the first application comprises one or more heartbeat messages received from said first application.

3. The method of claim 1, wherein said information associated with a first application comprises information about a first periodicity of heartbeat messages.

4. The method of claim 3, wherein said modified output comprises heartbeat messages with a second periodicity different to the first periodicity.

5. The method of claim 1, wherein said modified output comprises no heartbeat messages for normal heartbeat operation.

6. The method of claim 1, further comprising:
determining a heartbeat anomaly.

7. The method of claim 6, further comprising:
causing information about said heartbeat anomaly to be transmitted to the second device via the communication link.

8. A method, comprising:
causing a modified input to be received over a communication link, wherein the modified input is determined using information associated with a first application in a first device, said application being configured to communicate with a corresponding second application in a second device via a communication link, and information associated with said communication link.

9. The method of claim 8, wherein said information associated with a first application comprises one or more heartbeat messages received from said first application.

10. The method of claim 8, wherein said information associated with a first application comprises information about a first periodicity of heartbeat messages.

11. The method of claim 9, wherein said modified input comprises heartbeat messages with a second periodicity different to the first periodicity.

12. The method of claim 11, wherein the second periodicity is greater than or equal to the first periodicity.

13. The method of claim 8, wherein said modified input comprises no heartbeat messages for normal heartbeat operation.

14. The method of claim 8, further comprising:
causing information about a heartbeat anomaly to be received via the communication link.

15. The method of claim 14, further comprising:
causing a heartbeat anomaly to be indicated to the second application.

16. An apparatus comprising at least one processor and at least one memory including a computer program code, the at least one memory and the computer program code configured to, with the at least one processor, cause the apparatus at least to:
use information associated with a first application in a first device, said first application being configured to communicate with a corresponding second application in a second device via a communication link, and information associated with said communication link to determine a modified output; and
cause said modified output to be provided to said corresponding second application via said communication link.

17. An apparatus comprising at least one processor and at least one memory including a computer program code, the at least one memory and the computer program code configured to, with the at least one processor, cause the apparatus at least to:
cause a modified input to be received over a communication link, wherein the modified input is determined using information associated with a first application in a first device, said application being configured to communicate with a corresponding second application in a second device via a communication link, and information associated with said communication link.

18. A computer program product for a computer, comprising software code portions for performing the steps of the method of claim 1 when said product is run on the computer.

19. A computer program embodied on a non-transitory computer-readable storage medium, the computer program comprising program code for controlling a process to execute a process, the process comprising the steps of the method of claim 1.
